(19) United States
(12) Patent Application Publication
(10) Pub. No.: US 2014/0090736 A1
(43) Pub. Date: Apr. 3, 2014

(54) BURN PROTECTION SYSTEMS AND STANDOFFS FOR PIPING

(71) Applicant: BP CORPORATION NORTH AMERICA INC., Naperville, IL (US)

(72) Inventors: Jonathan Petersen, Friendswood, TX (US); Luis Otero, Houston, TX (US); Mike Conrad, Lafayette, LA (US)

(21) Appl. No.: 13/791,247

(22) Filed: Mar. 8, 2013

Related U.S. Application Data
(60) Provisional application No. 61/707,182, filed on Sep. 28, 2012.

(51) Int. Cl. F16L 59/02; B23P 11/00

(52) U.S. Cl. CPC F16L 59/02; B23P 11/00
USPC 138/103; 29/428

(57) ABSTRACT

A burn protection system for a pipe having a central axis comprises a standoff disposed about the pipe. The standoff includes a frame and a plurality of circumferentially spaced pipe engagement members coupled to the frame. Each pipe engagement member is radially positioned between the frame and the pipe and engages the pipe at a single point of contact. In addition, the burn protection system comprises a cage mounted to the frame of the standoff.

### CROSS-REFERENCE TO RELATED APPLICATIONS

This application claims benefit of U.S. provisional patent application Ser. No. 61/707,182 filed Sep. 28, 2012, and entitled “Burn Protection Systems and Standoffs for Piping,” which is hereby incorporated herein by reference in its entirety.

### STATEMENT REGARDING FEDERALLY SPONSORED RESEARCH OR DEVELOPMENT

Not applicable.

### BACKGROUND

The invention relates generally to systems and devices for protecting individuals from being burned by contact with hot piping, More particularly, the invention relates to burn protection systems including standoffs that engage piping at point contacts.

Steel pipes are used extensively in the petrochemical industry to convey fluids (e.g., gases and liquids) between different locations. If the fluids conveyed through the pipe have a relatively high temperature, the pipe will also have an elevated temperature due to heat transfer between the fluids and the steel pipe. Pipes having a temperature in excess of about 140° F. present a burn hazard to individuals in close proximity to the pipes. In particular, direct contact with such hot pipe surfaces (intentional or unintentional) can result in severe burns.

One approach to protect individuals from hot pipe surfaces is to wrap the pipe in insulation. The insulation provides a physical and thermal barrier between individuals and the outer surface of the pipe, thereby preventing direct contact with the hot pipe. However, if the insulation gets wet or absorbs moisture, it often leads to a type of pipe corrosion referred to as Corrosion Under Insulation (CUI). Over time, CUI can compromise the integrity of the pipe, potentially resulting in failure of the pipe and subsequent release of hazardous fluids into the surrounding environment.

Another conventional approach to protect individuals from hot pipes is to install an expanded metal cage around the pipe. In particular, metal standoffs are directly attached to the pipe and extend radially outward therefrom. The expanded metal cage is mounted to the standoffs, and thus, is radially spaced from the hot pipe. Such cages prevent direct contact with the pipe and eliminate the threat of CUI. However, if sufficient surface area contact exists in tight spaces between the metal standoffs and the steel pipe, moisture accumulation in between the standoff and the pipe can lead to crevice corrosion. Over time, such crevice corrosion can compromise the integrity of the pipe and/or the standoff's.

### BRIEF SUMMARY OF THE DISCLOSURE

These and other needs in the art are addressed in one embodiment by a burn protection system for a pipe having a central axis. In an embodiment, the burn protection system comprises a standoff disposed about the pipe. The standoff includes a frame and a plurality of circumferentially spaced pipe engagement members coupled to the frame. Each pipe engagement member is radially positioned between the frame and the pipe and engages the pipe at a single point of contact. In addition, the burn protection system comprises a cage mounted to the frame of the standoff.

These and other needs in the art are addressed in another embodiment by a method for providing burn protection on a pipe having a central axis. In an embodiment, the method comprises (a) mounting a first annular standoff to the pipe. The first standoff includes a radially outer frame and a plurality of circumferentially spaced radially inner pipe engagement members coupled to the frame. In addition, the method comprises (b) engaging the pipe with each pipe engagement member of the first standoff at a single point of contact during (a). Further, the method comprises (c) mounting a cage to the first standoff.

These and other needs in the art are addressed in another embodiment by a standoff for a pipe. In an embodiment, the standoff comprises a first frame having a radially inner surface configured to be positioned proximal the pipe and a radially outer surface configured to be positioned distal the pipe. In addition, the standoff comprises a plurality of circumferentially spaced pipe engagement members coupled to the radially inner surface of the first frame. Each pipe engagement member is configured to engage the pipe at a single point of contact.

Embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a top view of an embodiment of a burn protection system in accordance with the principles described herein mounted to a pipe;

FIG. 2 is a cross-sectional end view of the burn protection system of FIG. 1 taken along section 2-2 of FIG. 1;

FIG. 3 is a side view of one of the standoffs of FIG. 1;

FIG. 4 is a cross-sectional end view of a burn protection system including an embodiment of a standoff in accordance with the principles described herein; and

FIG. 5 is a side view of the standoff of FIG. 4.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

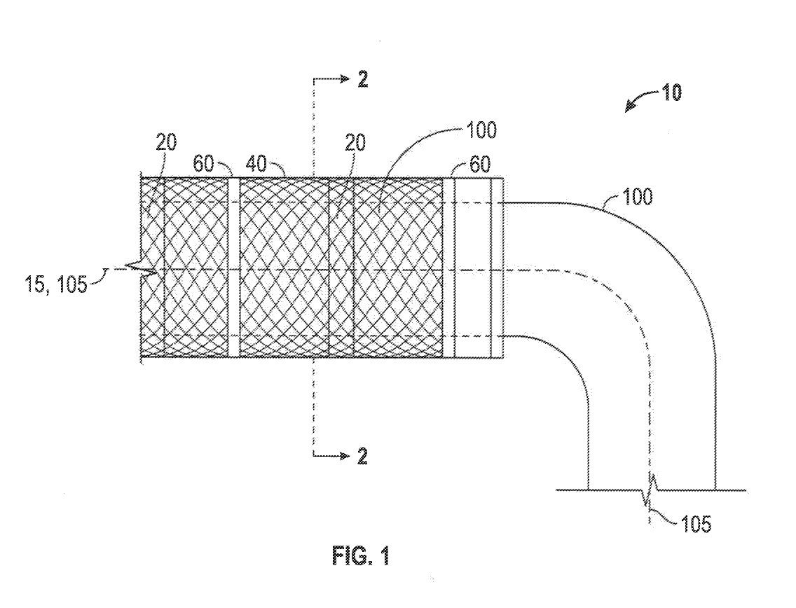

Referring now to FIG. 1, an embodiment of a burn protection system 10 for protecting personnel from a “hot” pipe 100 is shown. In general, “hot” pipes are pipes having an outside surface temperature greater than about 140° F. System 10 is mounted to pipe 100 and has a central or longitudinal axis 15 coaxially aligned with the central axis 105 of pipe 100. In this embodiment, system 10 includes a plurality of axially spaced annular standoffs 20 disposed about pipe 100, an annular cage 40 mounted to Standoffs 20, and a plurality of axially spaced bands 60 disposed about cage 40. Standoffs 20 are coupled to pipe 100 and radially space cage 40 from pipe 100, thereby enabling cage 40 to prevent an individual from directly contacting pipe 100 disposed therein. In this embodiment, cage 40 comprises one or more sheets of expanded metal formed around standoffs 20. As is known in the art, expanded metal includes a plurality of openings that allow visual inspection of pipe 100 disposed therein. In this embodiment, cage 40 is made of 0.051 gauge expanded aluminum. Bands 60 are metal straps wrapped around cage 40 to maintain the tubular shape of cage 40 and engagement between cage 40 and standoffs 20.

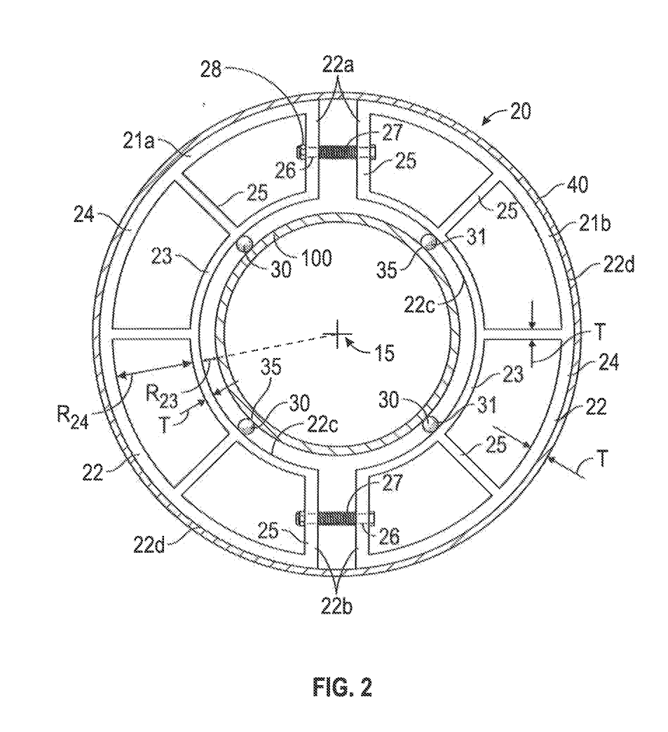

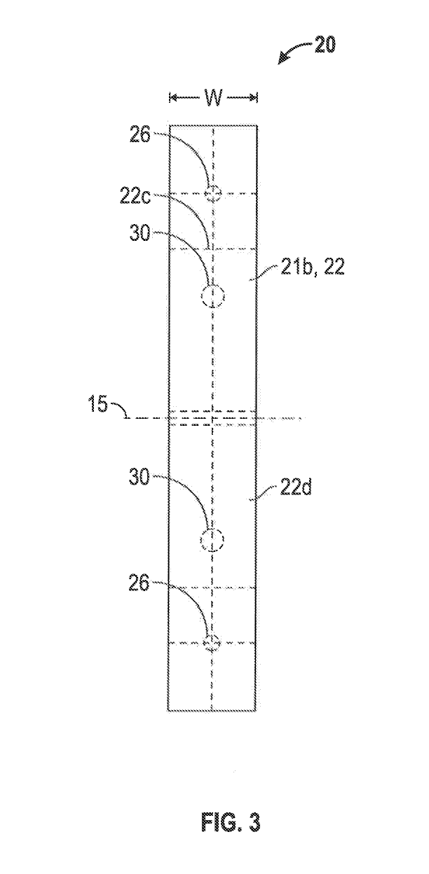

Referring to FIGS. 2 and 3, each standoff 20 is an annular split-ring including a first semi-circular or semi-annular segment 21a releasably coupled to a second semi-circular or semi-annular segment 21b. Segments 21a, 21b are disposed on opposite sides of pipe 100, each extending circumferentially about 180° around pipe 100. In this embodiment, each segment 21a, 21b is the same, and thus, only segment 21a will be described it being understood the other segment 21b is the same.

In this embodiment, segment 21a includes a semi-annular arcuate frame 22 and a plurality of circumferentially spaced pipe engagement members 30 attached to frame 22. When segment 21a is mounted to pipe 100, members 30 contact pipe 100 and radially spaced frame 22 from pipe 100. In other words, pipe engagement members 30 are radially positioned between frame 22 and pipe 100.

Referring still to FIGS. 2 and 3, frame 22 has a first end 22a, a second end 22b circumferentially opposite end 22a, a radially inner surface 22c extending circumferentially between ends 22a, 22b, and a radially outer surface 22d extending circumferentially between ends 22a, 22b. Pipe engagement members 30 are fixably attached to inner surface 22c, and cage 40 engages outer surface 22d. In this embodiment, each end 22a, 22b is planar and extends radially between surfaces 2.2c, 22d, and each surface 22c, 22d is semi-cylindrical and extends circumferentially between ends 22a, 22b.

In this embodiment, frame 22 comprises a radially inner base 23 defining inner surface 22c, a radially outer cage support 24 defining outer surface 22d, and a plurality of uniformly circumferentially spaced spokes or spacers 25 extending radially between base 23 and cage support 24. When standoff 20 is mounted to pipe 100, base 23 is radially proximal pipe 100, and cage support 24 is radially distal pipe 100. Spacers 25 extend radially from base 23 to cage support 24, thereby maintaining the radial spacing of base 23 and cage support 24. One spacer 25 is disposed at each end 22a, 22b. The spacer 25 disposed at each end 22a, 22b includes a hole or bore 26 extending therethrough.

In this embodiment, base 23, cage support 24, and each spacer 25 is formed from a relatively thin flat plate or band of material having a width W (measured axially relative to axis 15) and a thickness T (measured radially for base 23 and cage support 24, and measured circumferentially for spacers 25). Width W of base 23, cage support 24, and each spacer 25 preferably ranges from 1.0 to 2.0 in., and thickness T of base 23, cage support 24, and each spacer 25 preferably ranges from 1/16 in. to ¼ in., and is preferably ⅛ in. In addition, base 23 is radially spaced from pipe 100 by a radial distance R₂₃ preferably ranging from 0.25 in. to 0.75 in., and is preferably 0.5 in.; cage support 24 is radially spaced from base 23 by a radial distance R₂₄ preferably ranging from 1.0 to 4.0 in., and is preferably 2.0 in.; and spacers 25 are preferably uniformly circumferentially spaced 2.0 to 4.0 in. apart. In this embodiment, width W of base 23, cage support 24, and each spacer 25 is 2.0 in., thickness T is ⅛ in., and radial distance R₂₄ is 2.0 in.

the components of frame 22 (i.e., base 23, cage support 24, and spacers 25) are each made of a durable, rigid material such as a metal (e.g., aluminum), metal alloy (e.g., carbon steel, stainless steel, etc.), composite material (e.g., carbon fiber and epoxy), polymer, etc. In particular, the components of frame 22 are preferably made of stainless steel due to its corrosion resistant properties. Carbon steel may be used but is preferably coated or painted to provide added corrosion protection. In this embodiment, each component of frame 22 is made of stainless steel.

As best shown in FIG. 2, pipe engagement members 30 are rigidly attached to base 23 (e.g., via welding) and extend radially inward from surface 22c. Each pipe engagement member 30 has an arcuate, and more specifically, a convex outer surface 31 for contacting pipe 100 at a single point of contact. In this embodiment, each pipe engagement member 30 is a sphere (e.g., a ball bearing), and thus, outer surfaces 31 are spherical. The outer diameter of each spherical member 30 is preferably between 0.25 and 0.75 in., and more preferably 0.5 in. In this embodiment, standoff 20 includes a total of four uniformly circumferentially-spaced pipe engagement members 30—two members 30 are attached to each frame 20. In other embodiments different numbers of members 30 may be provided, however, each standoff 20 preferably includes at least four pipe engagement members 30.

Similar to the components of frame 22, each pipe engagement member 30 comprises a durable, rigid material such as a metal (e.g., aluminum), metal alloy (e.g., carbon steel or stainless steel), composite material (e.g., carbon fiber and epoxy), polymer, etc. In particular, each member 30 is preferably made of stainless steel (e.g., 316 stainless steel) due to its corrosion resistant properties. Carbon steel may be used but is preferably coated or painted to provide added corrosion protection. In this embodiment, each member 30 is made of stainless steel.

Referring now to FIGS. 1 and 2, system 10 is assembled by mounting each standoff 20 to pipe 100. Standoffs 20 are mounted at a plurality of axially spaced positions along the length of pipe 100. To mount each standoff 20 to pipe 100, segments 21a, 21b are disposed on opposite sides of pipe 100, and moved radially inward toward pipe 100 with each end 22a, 22b of one frame 22 opposed one end 22a, 22b of the other frame 22, and with each hole 26 of one frame 22 coaxially aligned with one hole 26 of the other frame 22. Next, a bolt 27 is disposed through each pair of aligned holes 26, and a nut 28 threaded onto the end of each bolt 27, thereby coupling opposed ends 22a, 22b of frames 22, and hence, coupling segments 21a, 21b, together. Nuts 28 are tightened to move segments 21a, 21b together and bring each member 30 into contact with pipe 100. Although bolts 27 and corresponding nuts 28 are used to couple segments 21a, 21b together in this embodiment, in general, any suitable coupling or connector may be used to couple segments 21a, 21b together. With standoffs 20 mounted to pipe 100, cage 40 is formed around standoffs 20 and axially spaced bands 60 are secured around cage 40 to hold cage 40 in position against standoffs 20. Although segments 21a, 21b are discrete and separate components coupled together with bolts 27 in this embodiment, in other embodiments, the segments (e.g., segments 21a, 21b) can be coupled with a hinge joint that allows them to be spread apart to receive the pipe (e.g., pipe 100) and then pivoted together to close around the pipe.

As best shown in FIG. 2, since each member 30 is spherical in this embodiment, each member 30 contacts cylindrical pipe 100 at a single point of contact 35, thereby minimizing the contact surface area between pipe 100 and each member 30 to prevent trapping or accumulation of any moisture therebetween that can lead to crevice corrosion. As a result, embodiments of standoffs 20 offer the potential to reduce undesirable corrosion and enhance the operating lifetimes of standoffs 20 and pipe 100.

In the embodiments previously described, each standoff 20 includes a plurality of spherical pipe engagement members 30. However, in general, the pipe engagement members (e.g., members 30) may have other suitable geometries that result in point contacts (as opposed to line or surface contacts) with pipe 1000 For example, in other embodiments, the pipe engagement members (e.g., members 30) may have other convex outer surface geometries (e.g., semi-spherical surfaces) or a conical outer surface geometry that engage pipe 100 at single points of contact.

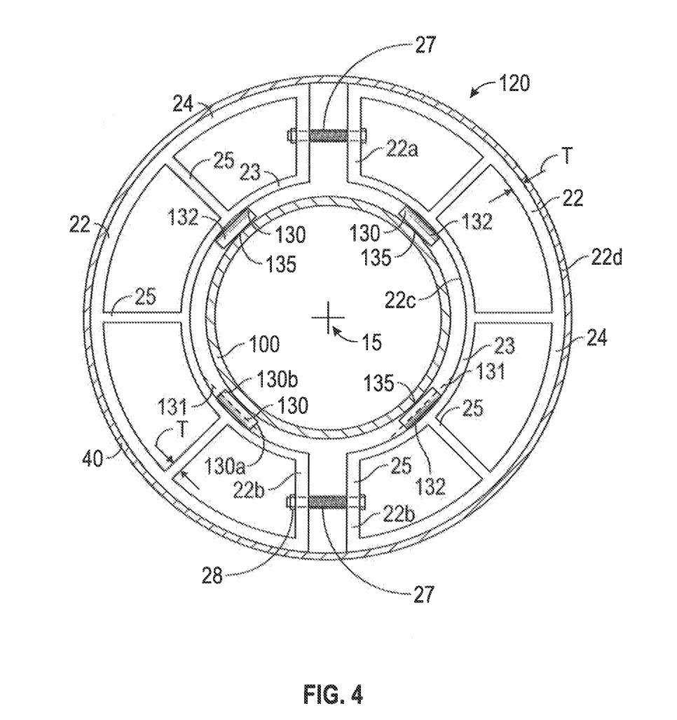

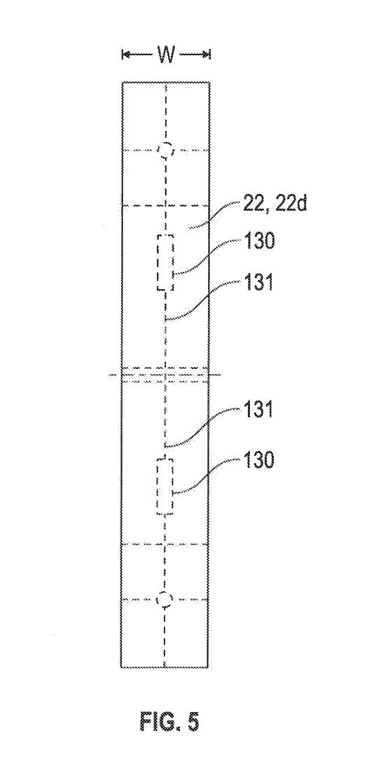

Referring now to FIGS. 4 and 5, an embodiment of a standoff 120 that may be used in system 10 in the place of any one or more standoffs 20 is shown. Standoff 120 is the same as standoff 20 previously described with the exception that pipe engagement members 30 having a spherical outer surface 31 are replaced by pipe engagement members 130 having a cylindrical outer surface 132. More specifically, in this embodiment, each member 130 has a central axis 131, a first end 130a, a second end 130b, and cylindrical outer surface 132 extending axially (relative to axis 131) between ends 130a, 130b. Each member 130 preferably has a diameter between 0.25 to 0.75 in., and more preferably 0.5 in.

Members 130 are uniformly circumferentially spaced and are fixably attached to base 23. In particular, the intersection of ends 130a, 130b and surface 132 of each member 130 is attached to inner surface 22c of the corresponding frame 22 (e.g., via welding). in addition, members 130 are oriented tangential to the outer surface of pipe 100 with axes 131 being disposed in a common plane oriented perpendicular to the central axis 15 of pipe 100. As a result, each cylindrical member 130 engages pipe 100 at a single point of contact 135 located between ends 130a, 130b, thereby minimizing the contact surface area between pipe 100 and each member 130 to prevent trapping or accumulation of any moisture therebetween that can lead to crevice corrosion. As a result, embodiments of standoffs 120 offer the potential to reduce undesirable corrosion and enhance the operating lifetimes of standoffs 120 and pipe 100.

Similar to members 30 previously described, each pipe engagement member 130 comprises a durable, rigid material such as a metal (e.g., aluminum) or metal alloy (e.g., carbon steel or stainless steel). In particular, each member 130 is preferably made of stainless steel due to its corrosion resistant properties. Carbon steel may be used but is preferably coated or painted to provide added corrosion protection. In this embodiment, each member 130 is made of stainless steel.

In the manner described, embodiments of burn protection systems (e.g., system 10) and standoffs (e.g., standoffs 20, 120) described herein engage a pipe (e.g., pipe 100) at discrete points of contact. As compared to line contacts or surface contacts common in conventional standoffs, point contacts provide reduced contact surface area, thereby offering the potential for reduced moisture accumulation and associated corrosion.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A burn protection system for a pipe having a central axis, the system comprising:
a standoff disposed about the pipe, wherein the standoff includes a frame and a plurality of circumferentially spaced pipe engagement members coupled to the frame;
wherein each pipe engagement member is radially positioned between the frame and the pipe and engages the pipe at a single point of contact;
a cage mounted to the frame of the standoff.

2. The system of claim 1, wherein the standoff comprises a split ring including a first semi-annular segment and a second semi-annular segment coupled to the first semi-annular segment;
wherein each semi-annular segment comprises a frame and a plurality of circumferentially spaced pipe engagement members.

3. The system of claim 2, wherein the first semi-annular segment and the second semi-annular segment are bolted together.

4. The system of claim 2, wherein each frame includes:
a radially inner base proximal the pipe;
a radially outer cage support member distal the pipe; and
a plurality of circumferentially spaced spacers extending radially from the base to the cage support member;
wherein each pipe engagement member is attached to the base.

5. The system of claim 4, wherein each base and each cage support member has an axial width ranging from 1.0 to 2.0 in.; and
wherein the cage support member is radially spaced 1.0 to 4.0 in. from the base of the corresponding frame.

6. The system of claim 1, wherein each pipe engagement member has a convex outer surface that engages the pipe at a single point of contact.

7. The system of claim 6, wherein each pipe engagement member is made of stainless steel.

8. The system of claim 6, wherein each pipe engagement member has a cylindrical or spherical outer surface.

9. The system of claim 8, wherein each pipe engagement member has a central axis and a cylindrical outer surface;
wherein the central axis of each pipe engagement member is disposed in a plane oriented perpendicular to the central axis of the pipe.

10. The system of claim 1, wherein the pipe engagement members radially space the frame 0.25 to 0.75 in. from the pipe.

11. The system of claim 10, wherein the pipe engagement members radially space the frame about 0.5 in. from the pipe.

12. A method for providing burn protection on a pipe having a central axis, the method comprising:
mounting a first annular standoff to the pipe, wherein the first standoff includes a radially outer frame and a plurality of circumferentially spaced radially inner pipe engagement members coupled to the frame;
(b) engaging the pipe with each pipe engagement member of the first standoff at a single point of contact during (a); and
(c) mounting a cage to the first standoff.

13. The method of claim 12, wherein each pipe engagement member of the first standoff has a convex outer surface that engages the pipe at a single point of contact.

14. The method of claim 13, wherein each pipe engagement member of the first standoff engages the pipe with a cylindrical or spherical outer surface.

15. The method of claim 13, wherein (a) comprises:
(a1) positioning a first and a second semi-annular segment on opposite sides of the pipe;
(a2) positioning a first end of the first semi-annular segment opposite a first end of the second semi-annular segment and positioning a second end of the first semi-annular segment opposite a second end of the second semi-annular segment;
(a3) moving the first and the second semi-annular segments radially inward toward each other; and
(a4) coupling the first end of the first semi-annular segment to the first end of the second semi-annular segment and coupling the second end of the first semi-annular segment to the second end of the second semi-annular segment.

16. The method of claim 15, wherein (a4) comprises:
bolting the first end of the first semi-annular segment to the first end of the second semi-annular segment; and
bolting the second end of the first semi-annular segment to the second end of the second semi-annular segment.

17. The method of claim 12, further comprising:
(d) mounting a second annular standoff to the pipe before (c), wherein the second standoff is axially spaced apart from the first standoff and includes a radially outer frame and a plurality of circumferentially spaced radially inner pipe engagement members coupled to the frame; and
(e) engaging the pipe with each pipe engagement member of the second standoff at a single point of contact during (d);
wherein (c) comprises mounting the cage to the first standoff and the second standoff.

18. A standoff for a pipe, the standoff comprising
a first frame having a radially inner surface configured to be positioned proximal the pipe and a radially outer surface configured to he positioned distal the pipe;
a plurality of circumferentially spaced pipe engagement members coupled to the radially inner surface of the first frame;
wherein each pipe engagement member is configured to engage the pipe at a single point of contact.

19. The standoff of claim 18, further comprising:
a second frame releasably coupled to the first frame, wherein the second frame has a radially inner surface configured to be positioned proximal the pipe and a radially outer surface configured to he positioned distal the pipe;
a plurality of circumferentially spaced pipe engagement members coupled to the radially inner surface of the second frame.

20. The standoff of claim 19, wherein the first frame is bolted to the second frame.

21. The standoff of claim 18, wherein the radially inner surface and the radially outer surface are each cylindrical surfaces.

22. The standoff of claim 18, wherein the first frame includes:
a radially inner base defining the radially inner surface;
a radially outer cage support member defining the radially outer surface; and
a plurality of circumferentially spaced spacers extending radially from the base to the cage support member.

23. The standoff of claim 18, wherein the base and the cage support member each have an axial width ranging from 1.0 to 2.0 in.; and
wherein the cage support member is radially spaced 1.0 to 4.0 in. from the base.

24. The standoff of claim 18, wherein each pipe engagement member has a cylindrical or spherical outer surface configured to engage the pipe at a single point of contact.

25. The standoff of claim 24, wherein each pipe engagement member is made of stainless steel.

26. The standoff of claim 24, wherein each pipe engagement member has a diameter between 0.25 and 0.75 in.

27. The standoff of claim 26, wherein each pipe engagement member has a diameter of 0.5 in.
